(19) United States
(12) Patent Application Publication
(10) Pub. No.: US 2025/0019496 A1
(43) Pub. Date: Jan. 16, 2025

(54) POLYAMIC ACID, POLYIMIDE FILM, AND FLEXIBLE METAL CLAD LAMINATE USING SAME

(71) Applicant: PI ADVANCED MATERIALS CO., LTD., Chungcheongbuk-do (KR)

(72) Inventors: Sung-Yul BACK, Seoul (KR); Kil-Nam LEE, Bucheon-si (KR); Min-Sang CHO, Incheon (KR); Su-Kyung CHAE, Incheon (KR)

(73) Assignee: PI ADVANCED MATERIALS CO., LTD., Chungcheongbuk-do (KR)

(21) Appl. No.: 18/712,133

(22) PCT Filed: Nov. 21, 2022
(86) PCT No.: PCT/KR2022/018410

§ 371 Date: May 21, 2024

(30) Foreign Application Priority Data
Nov. 22, 2021 (KR) 10-2021-0161645

(51) Int. Cl. C08G 73/10; C08J 5/18

(52) U.S. Cl. CPC C08G 73/1067; C08J 5/18; C08J 2379/08

(57) ABSTRACT

The present invention provides a polyamic acid, polyimide film and a flexible metal clad laminate using same, the polyamic acid comprising the following components copolymerized: an acid dianhydride component comprising biphenyl-tetracarboxylic acid dianhydride (BPDA), pyromellitic dianhydride (PMDA) and p-phenylenebis(trimellitate anhydride) (TAHQ); and a diamine component comprising m-tolidine and para-phenylenediamine (PPD).

### TECHNICAL FIELD

The present disclosure relates to a polyamic acid having excellent high-temperature storage modulus and low-dielectric properties, a polyimide film, and a flexible metal-clad laminate using the same.

### BACKGROUND ART

Polyimide (PI) is a polymeric material having the highest level of heat resistance, chemical compatibility, electrical insulation, chemical resistance, and weather resistance of all organic materials on the basis of an imide ring having excellent chemical stability along with a rigid aromatic main chain.

In particular, polyimide is attracting attention as a highly functional polymeric material in electrical, electronic, and optical fields due to having excellent insulation properties, that is, excellent electrical properties such as a low dielectric constant.

Recently, with weight reduction and size reduction in electronic products, flexible thin circuit boards with high integration density are being actively developed.

Such thin circuit boards tend to have a structure in which a circuit including a metal foil is formed on a polyimide film having excellent heat resistance, low-temperature resistance, and insulation properties while being easily bendable, which are widely used.

Flexible metal-clad laminates are mainly used as the thin circuit board, and examples thereof include flexible copper-clad laminates (FCCLs) using a thin copper plate as a metal foil. Furthermore, polyimide is also used in protective films, insulating films, and the like for thin circuit boards.

On the other hand, with various built-in functions in electronic devices, there has recently been a growing need to apply fast calculation and communication speeds to such devices. Additionally, thin circuit boards capable of high-speed communication based on high frequencies are being developed to meet these requirements.

There is a need for an insulator with a high impedance capable of maintaining electrical insulation properties even at high frequencies to realize high-speed communication at high frequencies. Impedance is inversely proportional to the dielectric constant (Dk) and frequency formed in the insulator, so the dielectric constant must be as low as possible to maintain insulation properties even at high frequencies.

However, in the case of existing polyimide, the level of dielectric properties is not excellent enough to maintain sufficient insulation properties in high-frequency communication.

Additionally, it is known that when an insulator has low-dielectric properties, the stray capacitance and noise, undesirably occurring in thin circuit boards, are likely to be reduced, thereby eliminating most of the causes of communication delays.

Therefore, polyimide having low-dielectric properties is recognized as the most important factor in the performance of thin circuit boards.

In particular, in the case of high-frequency communication, dielectric dissipation inevitably occurs through polyimide. A dielectric dissipation factor (Df) refers to the degree of electrical energy wasted in a thin circuit board and is closely related to signal transmission delays that determine communication speed. Thus, keeping the dielectric dissipation factor of polyimide as low as possible is also recognized as a key factor in the performance of thin circuit boards.

Additionally, the more moisture contained in a polyimide film, the greater the dielectric constant and the higher the dielectric dissipation factor. While being suitable as materials for thin circuit boards due to having excellent inherent properties, polyimide films may be relatively vulnerable to moisture due to the polar imide group, leading to deterioration in insulation properties.

Therefore, there is a need to develop a polyimide film having dielectric properties, especially a low dielectric dissipation factor, while maintaining the unique mechanical and thermal properties of polyimide to a predetermined level.

### DOCUMENT OF RELATED ART

### Patent Document

(Patent Document 1) Korean Patent Application Publication No. 10-2015-0069318

### DISCLOSURE

### Technical Problem

Accordingly, to solve the problems described above, the present disclosure aims to provide a polyamic acid having excellent high-temperature storage modulus and low-dielectric properties, a polyimide film, and a flexible metal-clad laminate using the same.

Hence, the present disclosure practically aims to provide specific embodiments thereof.

### Technical Solution

In a first embodiment of the present disclosure for achieving the objectives as described above, a polyamic acid including an acid dianhydride component and a diamine component to be copolymerized, the acid dianhydride component including biphenyl-tetracarboxylic dianhydride (BPDA), pyromellitic dianhydride (PMDA), and p-phenylenebis(trimellitate anhydride) (TAHQ), and
the diamine component including m-tolidine and para-phenylenediamine (PPD),
is provided

In a second embodiment of the present disclosure, a polyimide film obtainable by reacting a polyamic acid solution through an imidization reaction, the polyamic acid solution containing an acid dianhydride component including biphenyl-tetracarboxylic dianhydride (BPDA), pyromellitic dianhydride (PMDA), and p-phenylenebis(trimellitate anhydride) (TAHQ), and
a diamine component including m-tolidine and para-phenylenediamine (PPD),
is provided.

In a third embodiment of the present disclosure, a multilayer film including the polyimide film and a thermoplastic resin layer
is provided.

In a fourth embodiment of the present disclosure, a flexible metal-clad laminate including the polyimide film and an electrically conductive metal foil
is provided.

In a fifth embodiment of the present disclosure, an electronic component including the flexible metal-clad laminate
is provided.

### Advantageous Effects

As described above, the present disclosure provides a polyamic acid having excellent high-temperature storage modulus and low-dielectric properties while being composed of specific components in specific composition ratios and a polyimide film, which can thus be usefully applied to various fields in need of such properties, especially electronic components such as flexible metal-clad laminates.

### BEST MODE

Hereinafter, embodiments of the present disclosure will be described in more detail.

All terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Therefore, the embodiments described herein are merely examples and do not exhaustively present the technical spirit of the present disclosure. Accordingly, it should be appreciated that there may be various equivalents and modifications that can replace the embodiments and the configurations at the time at which the present application is filed.

As used herein, the singular forms are intended to include the plural forms as well, unless the context clearly indicates otherwise. It will be further understood that the terms “comprise”, “include”, “have”, and the like when used herein, specify the presence of stated features, integers, steps, components, or combinations thereof but do not preclude the presence or addition of one or more other features, integers, steps, components, or combinations thereof.

When an amount, concentration, other value, or parameter is given herein as a range, preferred range, or enumeration of preferred upper values and preferred lower values, it is to be understood to specifically disclose all ranges formed by a pair of any upper range limit or a preferred value and any lower range limit or a preferred value, regardless of whether the ranges are additionally disclosed.

When a range of numerical values is mentioned herein, this range is intended to include not only the endpoints but also all integers and fractions within the range, unless otherwise stated. The scope of the present disclosure is not intended to be limited to the specific values mentioned when defining the scope.

As used herein, although the term “acid dianhydride” is intended to include precursors or derivatives thereof, these compounds may not technically be acid dianhydride. Nevertheless, these compounds will react with diamine to form polyamic acids, which will be converted to polyimides once more.

As used herein, although the term “diamine” is intended to include precursors or derivatives thereof, these compounds may not technically be diamines. Nevertheless, these compounds will react with dianhydride to form polyamic acids, which will be converted to polyimides once more.

A polyamic acid, according to the present disclosure, may include an acid dianhydride component and a diamine component to be copolymerized, the acid dianhydride component including biphenyl-tetracarboxylic dianhydride (BPDA), pyromellitic dianhydride (PMDA), and p-phenylenebis(trimellitate anhydride) (TAHQ) and the diamine component including m-tolidine and para-phenylenediamine (PPD).

In one embodiment, in the polyamic acid, the biphenyl-tetracarboxylic dianhydride may have a content of 15 mol % or more and 70 mol % or less, the pyromellitic dianhydride may have a content of 10 mol % or more and 50 mol % or less, and the p-phenylenebis(trimellitate anhydride) may have a content of 5 mol % or more and 75 mol % or less, based on 100 mol % of the total content of the acid dianhydride component.

Additionally, the m-tolidine may have a content of 20 mol % or more and 45 mol % or less, and the para-phenylenediamine may have a content of 55 mol % or more and 80 mol % or less, based on 100 mol % of the total content of the diamine component.

In one embodiment, the polyamic acid may be a block copolymer containing two or more blocks.

A polyimide film, according to the present disclosure, may be obtainable by reacting a polyamic acid solution through an imidization reaction, the polyamic acid solution containing an acid dianhydride component including biphenyl-tetracarboxylic dianhydride (BPDA), pyromellitic dianhydride (PMDA), and p-phenylenebis(trimellitate anhydride) (TAHQ) and a diamine component including m-tolidine and para-phenylenediamine (PPD).

In one embodiment, in the polyimide film, the biphenyl-tetracarboxylic dianhydride may have a content of 15 mol % or more and 70 mol % or less, the pyromellitic dianhydride may have a content of 10 mol % or more and 50 mol % or less, and the p-phenylenebis(trimellitate anhydride) may have a content of 5 mol % or more and 75 mol % or less, based on 100 mol % of the total content of the acid dianhydride component.

The higher the p-phenylenebis(trimellitate anhydride) content, the lower the measured value of the dielectric dissipation rate of the polyimide film and, at the same time, the lower the storage modulus at a high temperature (300° C.).

Additionally, the m-tolidine may have a content of 20 mol % or more and 45 mol % or less, and the para-phenylenediamine may have a content of 55 mol % or more and 80 mol % or less, based on 100 mol % of the total content of the diamine component.

In one embodiment, the polyamic acid solution reacting through the imidization reaction to form the polyimide film may be a block copolymer containing two or more blocks.

In one embodiment, the biphenyl-tetracarboxylic dianhydride in a first block of the block copolymer may have a content of 50 mol % or more and 60 mol % or less based on 100 mol % of the total content of the acid dianhydride component in the polyimide film. Additionally, the m-tolidine in a second block may have a content of 30 mol % or more and 40 mol % or less based on 100 mol % of the total content of the diamine component in the polyimide film.

For example, the first block may be obtainable through imidization of biphenyl-tetracarboxylic dianhydride and para-phenylenediamine, and the second block may be obtainable through imidization of m-tolidine and pyromellitic dianhydride.

Additionally, biphenyl-tetracarboxylic dianhydride in the first block may be imidized completely with para-phenylenediamine, and m-tolidine in the second block may be imidized completely with pyromellitic dianhydride.

The m-tolidine has a hydrophobic methyl group and thus contributes to the low hygroscopicity of the polyimide film and the resulting low-dielectric properties of the polyimide film.

The polyimide chain derived from the biphenyl-tetracarboxylic dianhydride has a structure called a charge transfer complex (CTC), that is, a regular linear structure in which an electron donor and an electron acceptor are positioned close to each other, and the intermolecular interaction is strengthened.

Such a structure is effective in preventing hydrogen bonding with moisture and thus has an impact on reducing the moisture absorption rate, thereby maximizing the effect of reducing the hygroscopicity of the polyimide film.

In one specific example, the acid dianhydride component may further include pyromellitic dianhydride. Pyromellitic dianhydride, the acid dianhydride component having a relatively rigid structure, is preferable in terms of providing appropriate elasticity to the polyimide film.

In order for the polyimide film to satisfy both appropriate elasticity and moisture absorption rate, the content ratio of acid dianhydride is particularly important. For example, as the content ratio of biphenyl-tetracarboxylic dianhydride decreases, a low moisture absorption rate based on the CTC structure is hard to expect.

Additionally, while biphenyl-tetracarboxylic dianhydride contains two benzene rings corresponding to the aromatic moiety, pyromellitic dianhydride contains one benzene ring corresponding to the aromatic moiety.

The increase in the pyromellitic dianhydride content in the acid dianhydride component may be understood as an increase in the imide group within the molecule based on the same molecular weight, indicating that the ratio of the imide group derived from the pyromellitic dianhydride in the polyimide polymer chain increases relatively compared to that of the imide group derived from biphenyl-tetracarboxylic dianhydride.

In other words, an increase in the pyromellitic dianhydride content may be seen as a relative increase in the imide group in the entire polyimide film, making it difficult to expect a low moisture absorption rate.

On the contrary, when the content ratio of pyromellitic dianhydride decreases, this means that the component having a relatively rigid structure is reduced, so the elasticity of the polyimide film may deteriorate below the desired level.

For this reason, when the biphenyl-tetracarboxylic dianhydride content exceeds the above range or the pyromellitic dianhydride content is lower than the above range, the mechanical properties of the polyimide film deteriorate, and an appropriate level of heat resistance required to manufacture a flexible metal-clad laminate may not be obtainable.

On the contrary, when the biphenyl-tetracarboxylic dianhydride content is lower than the above range or the pyromellitic dianhydride content exceeds the above range, appropriate levels of dielectric constant and dielectric dissipation factor may be challenging to achieve, which is undesirable.

In one embodiment, the polyimide film may have a dielectric dissipation factor (Df) of 0.003 or less and a storage modulus of 100 MPa or more measured at a temperature of 300° C.

For example, the dielectric dissipation factor of the polyimide film may be 0.0028 or less, 0.0027 or less, 0.0026 or less, or 0.0025 or less.

Additionally, the storage modulus of the polyimide film measured at a temperature of 300° C. may be 2,000 MPa or less or 1,900 MPa or less.

In this regard, a polyimide film satisfying both the dielectric dissipation factor (Df) and the storage modulus measured at a temperature of 300° C. may be used as an insulating film for flexible metal-clad laminates. Furthermore, even when using such manufactured flexible metal-clad laminates as an electrical signal transmission circuit to transmit signals at a high frequency of 10 GHz or higher, the insulation stability thereof may be obtainable, and the signal transmission delays may be minimized.

While the polyimide film satisfying all of the conditions described above is a novel polyimide film that has not been known so far, the dielectric dissipation factor (Df) will be described in detail below. [71]

### <Dielectric Dissipation Factor>

“Dielectric dissipation factor” means the force dissipated by a dielectric (or insulator) when the friction of molecules obstructs the molecular motion caused by an alternating electric field.

The value of the dielectric dissipation factor is commonly used as an index to describe the ease of charge loss (dielectric dissipation). The higher the dielectric dissipation factor, the easier charge loss occurs. On the contrary, the lower the dielectric dissipation factor, the more difficult charge loss occurs. In other words, the dielectric dissipation factor is a measure of power loss, so communication speed may remain faster with the lower dielectric dissipation factor while mitigating signal transmission delays caused by power loss.

This is strongly required for the polyimide film, which is an insulating film, so the polyimide film, according to the present disclosure, may have a dielectric dissipation factor of 0.003 or less under an extremely high frequency of 10 GHz.

The preparation of the polyamic acid in the present disclosure may, for example, involve:
(1) a polymerization method by adding the entire amount of the diamine component in a solvent and then adding the acid dianhydride component so that the amount thereof is substantially equimolar to that of the diamine component;
(2) a polymerization method by adding the entire amount of the acid dianhydride component in a solvent and then adding the diamine component so that the amount thereof is substantially equimolar to that of the acid dianhydride component;
(3) a polymerization method by adding some of the diamine component to a solvent, mixing some of the acid dianhydride component in a ratio of about 95 to 105 mol % to the reaction component, adding the remaining diamine component, and then subsequently adding the remaining acid dianhydride component so that the diamine component and the acid dianhydride component are substantially equimolar;
(4) a polymerization method by adding some of the acid dianhydride component to a solvent, mixing some of the diamine compound in a ratio of about 95 to 105 mol % to the reaction component, adding the remaining acid dianhydride component, and then subsequently adding the remaining diamine component so that the diamine component and the acid dianhydride component are substantially equimolar;
(5) a polymerization method by reacting some of the diamine component and some of the acid dianhydride component in a first solvent so that either one is in excess to form a first composition, reacting some of the diamine component and some of the acid dianhydride component in a second solvent so that either one is in excess to form a second composition, and mixing the first and second compositions to complete polymerization, wherein when the diamine component is in excess when forming the first composition, the acid dianhydride component in the second composition is contained in an excessive amount, and when the acid dianhydride component is in excess in the first composition, the diamine component in the second composition is contained in an excessive amount to mix the first and second compositions so that the entire diamine component and acid dianhydride component used in the reaction are substantially equimolar; and the like.

However, the polymerization method is not limited to the above examples, and any known method may be used to prepare the first to third polyamic acids.

In one specific example, a formation method of the polyimide film, according to the present disclosure,
may include the following steps: preparing a polyamic acid by polymerizing an acid dianhydride component including biphenyl-tetracarboxylic dianhydride (BPDA), pyromellitic dianhydride (PMDA), and p-phenylenebis(trimellitate anhydride) (TAHQ) and a diamine component including m-tolidine and para-phenylenediamine (PPD); forming a film by positioning a precursor composition containing the polyamic acid on a support and imidizing the resulting product.

In the present disclosure, such a polymerization method of the polyamic acid described above may be defined as a random polymerization method. Additionally, the polyimide film of the present disclosure, formed from the polyamic acid prepared through such a process described above, is preferably applicable for maximizing the effect of the present disclosure in reducing the dielectric dissipation factor and moisture absorption rate.

However, the polymerization method makes the length of the repeating unit in the polymer chain described above relatively short, so there may be limitations in demonstrating each of the excellent properties of the polyimide chain derived from the acid dianhydride component. Therefore, block polymerization may be performed as the polymerization method of the polyamic acid, which is further preferably usable in the present disclosure.

On the other hand, the solvent for synthesizing the polyamic acid is not particularly limited, and any solvent capable of dissolving the polyamic acid may be usable. However, an amide-based solvent is preferably used.

Specifically, the solvent may be a polar organic solvent, which may be, in particular, a polar aprotic solvent. Examples thereof may include one or more selected from the group consisting of N,N-dimethylformamide (DMF), N,N-dimethylacetamide, N-methyl-pyrrolidone (NMP), gamma-butyrolactone (GBL), and diglyme, but the solvent is not limited thereto. If necessary, the solvent may be used alone, or two or more types may be used in combination.

In one example, N,N-dimethylformamide and N,N-dimethylacetamide are further preferably used as the solvent.

Additionally, in the polyamic acid preparation process, fillers may be added to improve various properties of the film, such as sliding properties, thermal conductivity, corona resistance, loop hardness, and the like. The filler added is not particularly limited, but preferred examples thereof includes silica, titanium oxide, alumina, silicon nitride, boron nitride, calcium hydrogen phosphate, calcium phosphate, mica, and the like.

The particle diameter of the filler is not particularly limited but may be determined depending on the properties of a film to be modified and the type of fillers to be added. Typically, the average particle diameter is in a range of 0.05 to 100 m, which is preferably in the range of 0.1 to 75 m, more preferably in the range of 0.1 to 50 m, and even more preferably in the range of 0.1 to 25 am.

When the particle diameter is smaller than the above range, the modification effect may be challenging to exhibit, and when the particle diameter exceeds the above range, the surface properties may be seriously damaged, or the mechanical properties may significantly deteriorate.

Additionally, the amount of the filler added is not particularly limited but may be determined by the properties of a film to be modified, the particle diameter of the filler, or the like. Typically, the amount of the filler added is in a range of 0.01 to 100 parts by weight with respect to 100 parts by weight of the polyimide, which is preferably in the range of 0.01 to 90 parts by weight and more preferably in the range of 0.02 to 80 parts by weight.

When the amount of the filler added is smaller than the above range, the modification effect by the filler may be challenging to exhibit, and when the amount of the filler added exceeds the above range, the mechanical properties of the film may be seriously damaged. The method of adding the filler is not particularly limited, and any known methods may be used.

In the formation method of the present disclosure, the polyimide film may be formed by a thermal imidization method and a chemical imidization method.

Additionally, the polyimide film may be formed by a complex imidization method in combination of the thermal imidization and chemical imidization methods.

The thermal imidization method is a method of inducing an imidization reaction using a heat source such as an infrared dryer or hot air, without involving a chemical catalyst.

The thermal imidization method may enable the amic acid group present in a gel film to be imidized by subjecting the gel film to heat treatment at a variable temperature in a range of 100° C. to 600° C. Specifically, the heat treatment may be performed at a temperature in a range of 200° C. to 500° C., which is more specifically in the range of 300° C. to 500° C., to imidize the amic acid group present in the gel film.

However, even in the gel film formation process, some of the amic acid (about 0.1 to 10 mol %) may be imidized. To this end, the polyamic acid composition may be dried at a variable temperature in a range of 50° C. to 200° C., which may also fall within the scope of the thermal imidization method.

In the case of the chemical imidization method, a dehydrating agent and an imidizing agent may be used according to methods known in the art to form the polyimide film.

As one example of the complex imidization method, a dehydrating agent and an imidizing agent may be introduced into a polyamic acid solution, heated at a temperature in a range of 80° C. to 200° C., which is preferably in the range of 100° C. to 180° C., partially cured and dried, and then heated at a temperature in a range of 200° C. to 400° C. for 5 to 400 seconds, thereby forming the polyimide film.

The present disclosure provides: a multilayer film including the polyimide film described above and a thermoplastic resin layer; and a flexible metal-clad laminate including the polyimide film described above and an electrically conductive metal foil.

Examples of the thermoplastic resin layer used may include a thermoplastic polyimide resin layer and the like.

The metal foil used is not particularly limited. However, when using the flexible metal-clad laminate of the present disclosure for electronic or electrical devices, the metal foil may, for example, include copper or an alloy thereof, stainless steel or an alloy thereof, nickel or an alloy thereof (including Alloy 42), and aluminum or an alloy thereof.

In typical flexible metal-clad laminates, copper foils, such as rolled copper foil and electrolytic copper foil, are widely used and are also preferably used in the present disclosure. Additionally, the surface of such metal foils may be coated with an anti-rust layer, a heat-resistant layer, or an adhesive layer.

The thickness of the metal foil is not particularly limited in the present disclosure and may be any thickness capable of demonstrating sufficient functions depending on the intended use.

The flexible metal-clad laminate, according to the present disclosure, may have a structure in which the metal foil is laminated onto one surface of the polyimide film or a structure in which an adhesive layer containing thermoplastic polyimide is added to one surface of the polyimide film, and the metal foil is laminated while being attached to the adhesive layer.

Additionally, the present disclosure provides an electronic component including the flexible metal-clad laminate as an electrical signal transmission circuit. The electrical signal transmission circuit may be an electronic component configured to transmit signals at a high frequency of at least 2 GHz, specifically at a high frequency of at least 5 GHz, and more specifically at a high frequency of at least 10 GHz.

Examples of the electronic component may include a communication circuit for a mobile phone, a communication circuit for a computer, or a communication circuit for aerospace but are not limited thereto.

### MODE FOR INVENTION

Hereinafter, the action and effect of the present disclosure will be described in detail through specific examples of the present disclosure. However, such examples are provided only for illustrative purposes, and the scope of the present disclosure is not limited to the following examples.

### Preparation Example

NMP was introduced while injecting nitrogen into a 500 mL reactor equipped with a stirrer and nitrogen injection/discharge pipes, and the reactor temperature was set to 30° C. Next, para-phenylenediamine (PPD) and m-tolidine as diamine components and biphenyl-tetracarboxylic dianhydride (BPDA), pyromellitic dianhydride (PMDA), and p-phenylenebis(trimellitate anhydride) (TAHQ) as acid dianhydride components were introduced in a predetermined order while being subjected to block copolymerization by raising the temperature to 40° C. under a nitrogen atmosphere to be heated with stirring for 120 minutes. As a result, a polyamic acid exhibiting a viscosity of 200,000 cP at 23° C. was prepared.

The prepared polyamic acid was rotated at a high speed of 1,500 rpm or more to remove gas bubbles. Then, a spin coater was used to coat a glass substrate with the resulting degassed polyimide precursor composition. Next, the resulting product was dried under a nitrogen atmosphere at a temperature of 120° C. for 30 minutes to form a gel film. The gel film was heated up to 450° C. at a rate of 2° C./min, subjected to heat treatment at 450° C. for 60 minutes, and then cooled down to 30° C. at a rate of 2° C./min to obtain a polyimide film.

Afterward, the polyimide film was dipped in distilled water and detached from the glass substrate. The polyimide film formed in such a manner had a thickness of 15 m. The thickness of the polyimide film was measured using an electric film thickness tester purchased from Anritsu.

### Examples 1 to 7 and Comparative Examples 1 to 3

Polyimide films were formed according to the preparation example described above by varying the components and the contents thereof as shown in Table 1 below.

TABLE 1

| | Acid dianhydride component | | | Diamine component | | |
|---|---|---|---|---|---|---|
| | (mol %) | | | (mol %) | | Polyamic acid |
| | PMDA | BPDA | TAHQ | m-Tolidine | PPD | polymerization |
| | (mol %) | (mol %) | (mol %) | (mol %) | (mol %) | method |
| Example 1 | 36 | 54 | 10 | 32 | 68 | Block |
| | | | | | | polymerization |
| Example 2 | 32 | 48 | 20 | 34 | 66 | Block |
| | | | | | | polymerization |
| Example 3 | 28 | 42 | 30 | 36 | 64 | Block |
| | | | | | | polymerization |
| Example 4 | 24 | 36 | 40 | 38 | 62 | Block |
| | | | | | | polymerization |
| Example 5 | 20 | 30 | 50 | 40 | 60 | Block |
| | | | | | | polymerization |
| Example 6 | 16 | 24 | 60 | 42 | 58 | Block |
| | | | | | | polymerization |
| Example 7 | 12 | 18 | 70 | 44 | 56 | Block |
| | | | | | | polymerization |
| Comparative | 8 | 12 | 80 | 46 | 54 | Block |
| Example 1 | | | | | | polymerization |
| Comparative | 4 | 6 | 90 | 48 | 52 | Block |
| Example 2 | | | | | | polymerization |
| Comparative | 0 | 0 | 100 | 50 | 50 | Block |
| Example 3 | | | | | | polymerization |

### <Experimental Example> Evaluation of Dielectric Dissipation Factor and Storale Modulus

The dielectric dissipation factor and storage modulus were measured for each polyimide film formed in Examples 1 to 7 and Comparative Examples 1 to 3. The results thereof are shown in Table 2 below.

### (1) Measurement of Dielectric Dissipation Factor (Df)

For the dielectric dissipation factor (Df), a sample was dried in an oven at 130° C. for 30 minutes and left for 24 hours in an environment where the relative humidity at 23° C. was 50%. Then, a network analyzer purchased from Keysight and an SPDR resonator purchased from QWED were used to measure a dielectric dissipation factor at 10 GHz.

### (2) Measurement of Storage Modulus

The storage modulus of each film was calculated using DMA, and the value at 300° C. was measured.

TABLE 2

| | | Storage modulus at 300° C. |
|---|---|---|
| | Df | (MPa) |
| Example 1 | 0.0024 | 1533 |
| Example 2 | 0.0023 | 1272 |
| Example 3 | 0.0022 | 1026 |
| Example 4 | 0.0021 | 796 |
| Example 5 | 0.0021 | 582 |
| Example 6 | 0.002 | 384 |
| Example 7 | 0.0019 | 132 |
| Comparative Example 1 | 0.0018 | 0 |
| Comparative Example 2 | 0.0017 | 0 |
| Comparative Example 3 | 0.0016 | 0 |

As shown in Table 2 above, it is confirmed that the polyimide films, formed according to the examples of the present disclosure, not only exhibit a significantly low dielectric dissipation factor, which is 0.003 or less, but also show a desired level of high-temperature storage modulus.

These results are achieved by the components and composition ratio specified herein, showing that the content of each component plays a decisive role.

On the other hand, the polyimide films of Comparative Examples 1 to 3, whose components differ from those in the examples, have significantly poor storage modulus properties at a high temperature, leading to the expectation that the use of such polyimide films may be challenging in electronic components where signal transmission occurs at high frequencies.

Although the present disclosure has been described above with reference to examples of the present disclosure, those skilled in the art will be able to make various applications and modifications based on the above contents within the scope of the present disclosure.

### INDUSTRIAL APPLICABILITY

As described above, the present disclosure provides a polyamic acid having excellent high-temperature storage modulus and low-dielectric properties while being composed of specific components in specific composition ratios and a polyimide film, which may thus be usefully applied to various fields in need of such properties, especially electronic components such as flexible metal-clad laminates.

1. A polyamic acid comprising an acid dianhydride component and a diamine component to be copolymerized, the acid dianhydride component comprising biphenyl-tetracarboxylic dianhydride (BPDA), pyromellitic dianhydride (PMDA), and p-phenylenebis(trimellitate anhydride) (TAHQ) and the diamine component comprising m-tolidine and para-phenylenediamine (PPD).

2. The polyamic acid of claim 1, wherein the biphenyl-tetracarboxylic dianhydride has a content of 15 mol % or more and 70 mol % or less, the pyromellitic dianhydride has a content of 10 mol % or more and 50 mol % or less, and the p-phenylenebis(trimellitate anhydride) has a content of 5 mol % or more and 75 mol % or less, based on 100 mol % of the total content of the acid dianhydride component.

3. The polyamic acid of claim 1, wherein the m-tolidine has a content of 20 mol % or more and 45 mol % or less, and
the para-phenylenediamine has a content of 55 mol % or more and 80 mol % or less, based on 100 mol % of the total content of the diamine component.

4. The polyamic acid of claim 1, wherein the polyamic acid is a block copolymer comprising two or more blocks.

5. A polyimide film obtainable by reacting a polyamic acid solution through an imidization reaction, the polyamic acid solution comprising:
an acid dianhydride component comprising biphenyl-tetracarboxylic dianhydride (BPDA), pyromellitic dianhydride (PMDA), and p-phenylenebis(trimellitate anhydride) (TAHQ); and
a diamine component comprising m-tolidine and para-phenylenediamine (PPD).

6. The polyimide film of claim 5, wherein the biphenyl-tetracarboxylic dianhydride has a content of 15 mol % or more and 70 mol % or less, the pyromellitic dianhydride has a content of 10 mol % or more and 50 mol % or less, and the p-phenylenebis(trimellitate anhydride) has a content of 5 mol % or more and 75 mol % or less, based on 100 mol % of the total content of the acid dianhydride component.

7. The polyimide film of claim 5, wherein the m-tolidine has a content of 20 mol % or more and 45 mol % or less, and
the para-phenylenediamine has a content of 55 mol % or more and 80 mol % or less, based on 100 mol % of the total content of the diamine component.

8. The polyimide film of claim 5, wherein the polyamic acid of the polyamic acid solution is a block copolymer comprising two or more blocks.

9. The polyimide film of claim 8, wherein the biphenyl-tetracarboxylic dianhydride in a first block of the block copolymer has a content of 50 mol % or more and 60 mol % or less based on 100 mol % of the total content of the acid dianhydride component in the polyimide film, and
the m-tolidine in a second block has a content of 30 mol % or more and 40 mol % or less based on 100 mol % of the total content of the diamine component in the polyimide film.

10. The polyimide film of claim 5, wherein a dielectric dissipation factor (Df) is 0.003 or less, and
a storage modulus measured at a temperature of 300° C. is 100 MPa or more.

11. A multilayer film comprising:
the polyimide film of claim 5; and
a thermoplastic resin layer.

12. (canceled)

13. (canceled)
